(19) United States
(12) Patent Application Publication
(10) Pub. No.: US 2026/0087642 A1
(43) Pub. Date: Mar. 26, 2026

(54) SYSTEM AND METHOD FOR TRACKING AN OBJECT

(71) Applicant: Tyco Fire & Security GmbH, Neuhausen am Rheinfall (CH)

(72) Inventors: Mark Richard PATERSON, Newtownards (GB); Marco CIACCO, Belfast (GB)

(21) Appl. No.: 19/337,129

(22) Filed: Sep. 23, 2025

Related U.S. Application Data
(60) Provisional application No. 63/697,929, filed on Sep. 23, 2024.

(51) Int. Cl. G06T 7/20; H04N 23/695; H04N 23/90

(52) U.S. Cl. CPC G06T 7/20; H04N 23/695; H04N 23/90; G06T 2207/30241; G06V 2201/07

(57) ABSTRACT

A tracking system is disclosed. The system includes a plurality of cameras to capture a plurality of video streams. The system includes a processing unit configured to identify an object of interest in a video stream from the plurality of video streams, determine one or more future routes of travel for the object, identify one or more cameras associated with future routes of travel, determine ingress and egress points for each camera based on the future routes, generate commands to set the cameras to the ingress points, and generate and transmit a unique identifier for the object to the one or more cameras. The cameras are configured to track the object from the ingress point to the egress point when the object is identified in the video stream of the camera.

### CROSS-REFERENCE TO RELATED APPLICATION

This patent application claims the benefit of U.S. Provisional Application No. 63/697,929, filed on Sep. 23, 2024, titled “SYSTEM AND METHOD FOR TRACKING AN OBJECT.” The disclosure of the prior application is hereby incorporated by reference in its entirety.

### TECHNICAL FIELD

The present disclosure relates to video-based object tracking systems, and more particularly, to automated systems and methods for tracking objects across multiple camera feeds using artificial intelligence to predict object routes and dynamically assign tracking resources.

### BACKGROUND

Generally, video-based object tracking environments includes multiple fixed and pan-tilt-zoom (PTZ) cameras providing overlapping or disjoint fields of view, monitored via a user interface and a processing unit. In conventional deployments, locating and following an object of interest across cameras often requires manual operator intervention: selecting the object, anticipating the object's likely route, switching camera views, and controlling PTZ presets. These manual workflows are time-consuming, do not scale with camera count or scene activity, and are susceptible to missed handoffs and inconsistent tracking continuity.

Additional challenges include ambiguous handoff decisions caused by incomplete or non-overlapping coverage; limited use of historical patterns, topology, or ingress/egress mapping to predict future paths; and the absence of a standardized unique identifier that can be propagated to cameras for reliable re-identification. After initial detection, operators frequently must re-acquire the object as the object moves between fields of view, and PTZ cameras must be manually steered to likely ingress points before the object arrives. Other challenges include dynamically prioritizing and assigning cameras to current and predicted object routes, coordinating primary and secondary display views for situational awareness, and reconstructing a coherent travel history from multiple video streams. Furthermore, when an object deviates from an expected route, conventional systems often lose track and cannot reliably re-establish it without restarting the process.

There is therefore a need to provide a system and method for automated cross-camera object tracking system that alleviates drawbacks of conventional video tracking systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect of the present disclosure, a tracking system is provided that includes a plurality of cameras and a processing unit. The cameras may be configured to capture a plurality of video streams. The processing unit may be configured to have a memory and a processor in communication with the memory. The processor may be configured to identify an object of interest in a video stream from the plurality of video streams, determine one or more future routes of travel for the object, identify one or more cameras associated with future routes of travel, determine ingress and egress points for each camera based on the future routes, generate commands to set the cameras to the ingress points, and generate and transmit a unique identifier for the object to the one or more cameras. The cameras may be further configured to track the object from the ingress point to the egress point when the object is identified in the video stream of the camera. In certain aspects, the system is further operable to coordinate tracking across both fixed and pan-tilt-zoom (PTZ) cameras, and to dynamically update tracking parameters in response to changes in the object's route and/or environmental conditions.

In another aspect, the present disclosure provides a processor configured to display, on a user interface, the video stream in which the object of interest is currently present as a primary view.

In another aspect, the processor may be configured to display video streams from the cameras through which the object has previously passed. Or is predicted to pass, as one or more secondary views on the user interface, thereby enhancing situational awareness and enabling retrospective and prospective monitoring.

In another aspect, the processor may be configured to re-establish tracking using the unique identifier of the object when the object deviates from the predicted future route, such that tracking continuity is maintained even in the event of unexpected object behavior or route changes.

In some aspects, one or more cameras may be configured as pan-tilt-zoom (PTZ) cameras. The system may utilize PTZ functionality to automatically reposition cameras to optimal viewpoints based on predicted object movement.

In some aspects, the processor may be configured to receive the video streams from cameras through which the object has passed, and to generate a composite video or travel log depicting the object's trajectory across the monitored environment, which may be stored for later review or analysis.

In another aspect of the present disclosure, a method is provided for tracking an object in video streams. The method may include identifying an object of interest in a video stream from the plurality of video streams, determining one or more future routes of travel for the object, identifying one or more cameras associated with future routes of travel, determining ingress and egress points for each camera based on the future routes, generating commands to set the cameras to the ingress points, generating and transmitting a unique identifier for the object to the one or more cameras, and tracking the object from the ingress point to the egress point when the object is identified in the video stream of the camera. The method may further include dynamically updating the predicted routes and camera assignments in response to near real-time tracking data.

In further aspects of the disclosure, the method includes a step of displaying on a user interface, the video stream in which the object of interest is currently present as a primary view.

In some aspects, the method includes a step of displaying video streams from cameras through which the object has passed or is predicted to pass as secondary views on the user interface.

In some embodiments, one or more cameras are pan-tilt-zoom (PTZ) cameras.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents. It will be appreciated that modifications and variations to the described embodiments may be made without departing from the scope of the present disclosure, as defined by the appended claims

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic view of a video-based tracking system, in accordance with an example of various aspects of the present disclosure.

FIG. 2 depicts an example of a user interface of the video-based tracking system of FIG. 1, in accordance with an example of various aspects of the present disclosure.

FIG. 3 is a flowchart depicting steps of a method to track an object, in accordance with an example of aspects of the present disclosure.

### DETAILED DESCRIPTION

One or more specific aspects of the present disclosure will be described below. These described aspects are only examples of the presently disclosed techniques. Additionally, in an effort to provide a concise description of these aspects, certain features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but may nevertheless be a routine undertaking of design, fabrication, and manufacture for those of ordinary skill having the benefit of this disclosure.

When introducing elements of various aspects of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one aspect” or “an aspect” of the present disclosure are not intended to be interpreted as excluding the existence of additional aspects that also incorporate the recited features.

The present disclosure provides a video-based tracking system configured for automated, cross-camera object tracking and seamless integration of pan-tilt-zoom (PTZ) functionality.

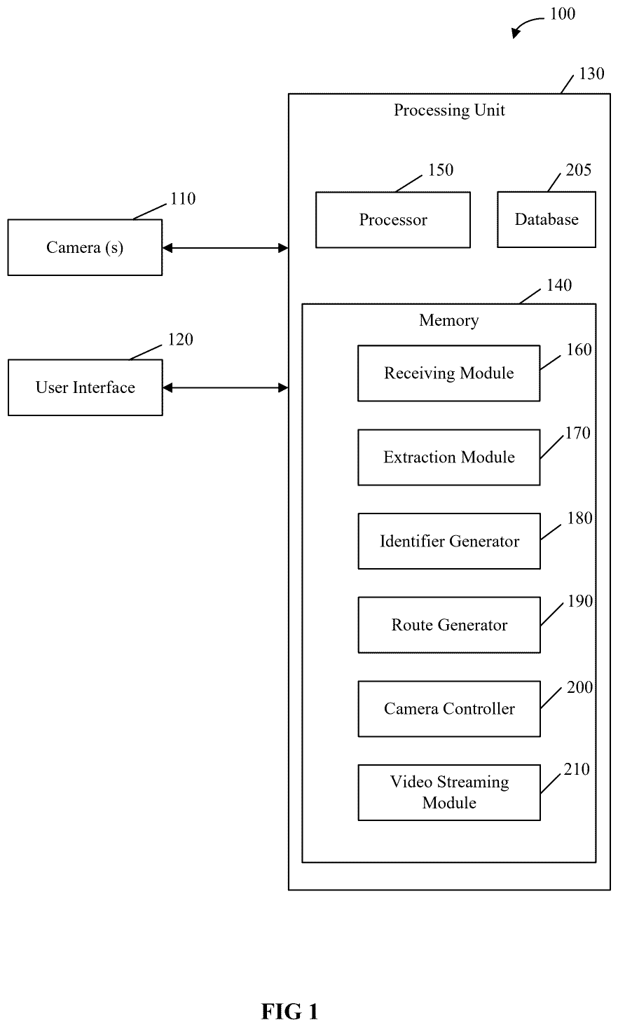

FIG. 1 is a schematic view depicting a system 100, according to some aspects of the present disclosure. The system 100 may be configured to include a plurality of cameras 110, a user interface 120, and a processing unit 130. One or more cameras 110 may be pan-tilt-zoom (PTZ) cameras. The cameras 110 may be positioned to cover various areas/sections of a site. The cameras 110 may be configured to capture video stream of the areas/sections of the site and transmit the video stream to the processing unit 130. The user interface 120 may be in communication with the processing unit 130, wherein the processing unit 130 displays selective video streams on the user interface 120. The user interface 120 may include a display to showcase video streams and an input module to receive input from a user. The display may be a touchscreen to receive the input. In some other aspects, other input means, such as, a keyboards, mouse devices, gesture-based controllers, voice recognition modules, or augmented-reality (AR) head-mounted displays, may be provided with the display to facilitate reception of inputs from the user. In some embodiments, the user interface further provides interactive overlays for object selection, route visualization, and event acknowledgment.

In some aspects, the processing unit 130 may be configured to include a memory 140 and a processor 150 communicatively coupled with the memory 140. The memory 140 may include one or more devices (e.g., memory units, memory devices, storage devices, etc.) for storing data and/or computer code for completing and/or facilitating the various processes described in the present disclosure. The memory 140 may include random access memory (RAM), read-only memory (ROM), hard drive storage, temporary storage, non-volatile memory, flash memory, optical memory, phase-change memory (PCM), magnetoresistive random-access memory (MRAM), or any other suitable volatile or non-volatile memory technology now known or later developed. The memory 140 may include database components, object code components, script components, or any other type of information structure for supporting the various activities and information structures described in the present disclosure. The memory 140 may be communicably connected with the processor 150 via a processing circuit and may include computer code for executing (e.g., by the processor 150) one or more processes described herein.

The processor 150 may be a general purpose or specific purpose processor, an application specific integrated circuit (ASIC), one or more field programmable gate arrays (FPGAs), a group of processing components, a graphics processing unit (GPU), a tensor processing unit (TPU), or other suitable processing components. The processor 150 may be configured to execute computer code or instructions stored in the memory 140 or received from other computer readable media (e.g., CDROM, network storage, a remote server, etc.).

The processing unit 130 may be configured to identify an object of interest in a video stream from the plurality of video streams. In some aspects, the processing unit 130 may be provided with details of objects to be identified. In some other aspects, the system 100 may include one or more sensors (e.g., lidar units, radar modules, RFID readers, Bluetooth beacons, infrared emitter-receiver pairs, or access-control badge readers, etc.) whose data streams are fused with video data to improve object identification using predetermined rules, machine-learning classifiers, or hybrid rule- and AI-based approaches.

In some aspects, the system 100 may receive details of the object of interest from a user. The memory 140 includes a receiving module 160 configured to receive a request to track an object in a video stream from a plurality of video streams being displayed on the user interface 120. Such request may be received from a user viewing the video streams. The user may provide the request by selecting an object or marking a boundary box on the user interface 120 around the object. The memory 140 further includes an extraction module 170 to extract the object from the request or details of the object provided. The extraction module 170 may be configured to extract at least one image of the object from the video stream based on received request. The extraction module 170 may employ image-processing techniques—such as histogram of oriented gradients (HOG), scale-invariant feature transform (SIFT), or deep-learning-based segmentation—to isolate and extract the object from the video stream.

The memory 140 further includes an identifier generator 180 configured to generate a unique identifier corresponding to the object. Generating the unique identifier may include applying an algorithm to the object in the image to obtain an identifier that is unique so that the identifier can be associated with the object. For example, in case of the object being a vehicle, the unique identifier may be a registration number plate of the vehicle. In another example, in case of the object being a human being, the unique identifier can be color of a clothing item. The identifier may include combination of two or more features of the object. For example, in case of the object being a vehicle, the identifier may be color and type of the vehicle. In certain embodiments, biometric or soft-biometric attributes (e.g., gait, body ratios, facial landmarks) may be incorporated into the unique identifier to enhance re-identification accuracy across disparate cameras.

The memory 140 further includes a route generator 190 configured to determine future route of the object. The route generator 190 may implement artificial intelligence techniques to determine the future route(s). For example, the route generator 190 may be trained with path taken by objects similar to the objects of interest, and the route generator 190 may utilize historic data to determine the future route for the object of interest. The route generator 190 may implement any other suitable technique. For example, the route generator 190 may determine the future route(s) based on entry and exit points available for the object of interest. In some other aspects, the route generator 190 may utilize predefined paths for different objects stored in a database 205 of the processing unit 130. The route generator 190 may extract the predefined path of an object matching with the object of interest as the future path for the object of interest. Additionally, probabilistic graphical models, reinforcement-learning agents, or hybrid Bayesian/neural architectures may be employed to continuously refine route predictions in real time.

The memory 140 further includes a camera controller 200 configured to identify one or more cameras 110 associated with future routes of travel. In some aspects, the camera controller 200 fetches the future path(s) from the route generator 190 and identifies video streams having the future path. The cameras 110 capturing those video streams may be identified as capturing the future route(s). In some other aspects, details of the cameras 110 associated with capturing various sections of the site may be stored in the database 205. The camera controller 200 further determines ingress and egress points for each camera 110 based on the future routes and generates commands to set the cameras 110 to the ingress points. In some aspects, the camera controller 200 may generate commands to set all identified cameras 110 to respective ingress points. In some other aspect, the camera controller 200 may generate commands to set the camera 110 capturing immediately next section of the future route. The commands may be transmitted using Open Network Video Interface Forum (ONVIF) messages, Real-Time Streaming Protocol (RTSP) commands, proprietary camera-control protocols, or edge-compute software-development-kit (SDK) interfaces, thereby permitting vendor-agnostic integration.

Further, the camera controller 200 fetches the unique identifier from the identifier generator 180, and transmits the unique identifier to the identified camera(s) 110. The cameras 110 are further configured to track the object from the ingress point to the egress point when the object is identified in the video stream of the camera 110. The camera 110 utilizes the unique identifier to identify the object. The camera 110 transmits the video stream to the processing unit 130, wherein the memory 140 includes a video streaming module 210 that receives the video stream having the object and displays the video stream on the user interface 120. The video streaming module 210 displays the video stream having the object of interest as a primary view on the user interface 120. The video streaming module 210 additionally ingests video streams from other cameras 110 whose fields of view the object has already traversed and/or is predicted to traverse according to the calculated the future routes. The video streaming module 210 displays the video streams having the object passed through and/or potentially to pass on the user interface 120 as a secondary view on the user interface 120. In certain embodiments, tertiary or quaternary context views (e.g., heat-maps, corridor overlays) may also be rendered to assist operators in proactive decision-making.

When the object passes through one video stream, the camera controller 200 may set the camera 110 having next section of the future route to the ingress point, and tracking of the object continues when the object is identified in the video stream of that camera 110. The primary view on the user interface 120 is dynamically changed by the video streaming module 210, and a video stream having the object is displayed as the primary view. One or more displayed video stream may be displayed as a past travel path of the object of interest.

The video streaming module 210 may receive all video streams through which the object has passed from the cameras 110, and generate a video showing a consolidated timeline of travel of the object based on received video streams. The video may be stored in the database 205 with timestamps and metadata (e.g., geolocation, camera identifier, confidence scores) for future references.

Although FIG. 1 shows components of the processing unit 130 and components of the memory 140 in one boundary, these components may not necessarily be contained in a single equipment, and one or more components of the processing unit 130 and/or the memory 140 may be contained in different processing equipment or processing systems. For example, the processing unit 130 may be distributed across an edge gateway, an on-premises server, and a cloud-based analytics platform, with functional modules executing cooperatively via containerized microservices.

The processing unit 130 may be configured to re-establish tracking using the unique identifier of the object when the object deviates from the predicted future route. By leveraging the unique identifier—together with scene understanding models and cross-camera hand-off logic—the processing unit 130 can search concurrent and historical video feeds, re-acquire the object of interest, and dynamically update route predictions without requiring manual operator intervention. As one illustrative example, if a tracked individual unexpectedly climbs a ladder into an elevated area that is outside the original prediction corridor, the system can autonomously locate that individual in an overlapping rooftop camera, generate a new set of ingress/egress points, and continue seamless tracking.

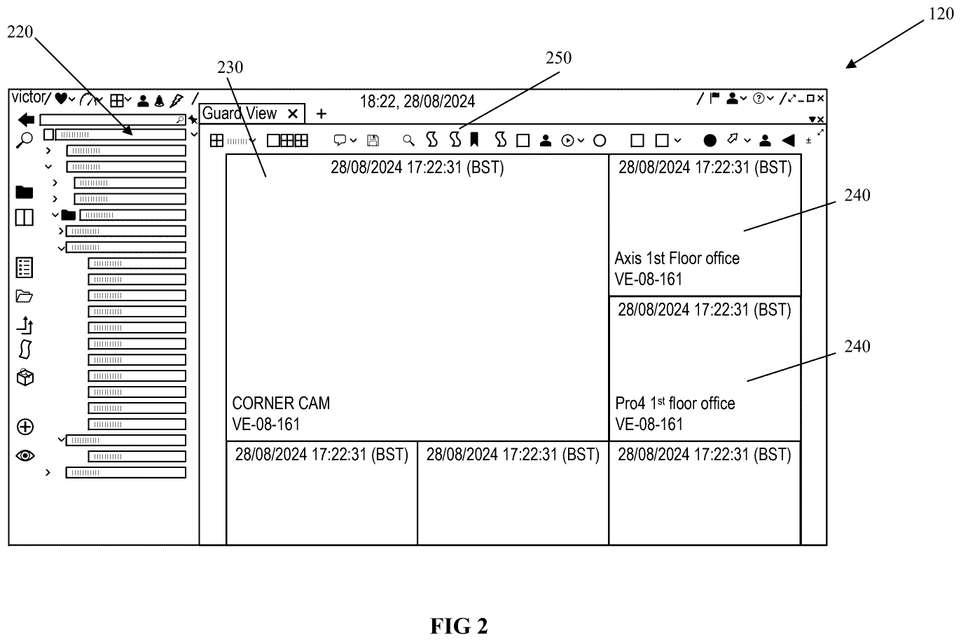

FIG. 2 depicts an illustrative, non-limiting, example of the user interface 120 of the system 100. The user interface 120 may have a display screen 220 (which may be a single monitor, a multi-monitor workstation, a head-mounted display, or any other suitable visualization device) having the primary view 230 and one or more secondary views 240. The primary view 230 presents, in near-real time, the camera feed currently containing the object of interest and therefore depicts the present location of the object and route segment. The secondary views 240 may concurrently display past and/or future routes of the object as determined by predictive analytics, historical replay, or user selection. Before initiating tracking of the object, the video streaming module 210 may display multiple video streams as the primary view 230 and the secondary view 240 to enable a user to select the object of interest (e.g., via mouse click, touch gesture, voice command, and/or gaze tracking).

The user interface 120 may include input icons 250 for receiving input from the user. Such icons may represent, by way of example only, play/pause controls, PTZ presets, heat-map overlays, or alarm acknowledgement buttons. Based on the input, the processing unit 130 may alter views on the user interface 120 or process the object of interest selected by the user, for instance by re-ranking camera priorities, adjusting prediction horizons, or triggering forensic export of relevant clips. In some example aspects, a clip can be a video stream or a portion of a video stream.

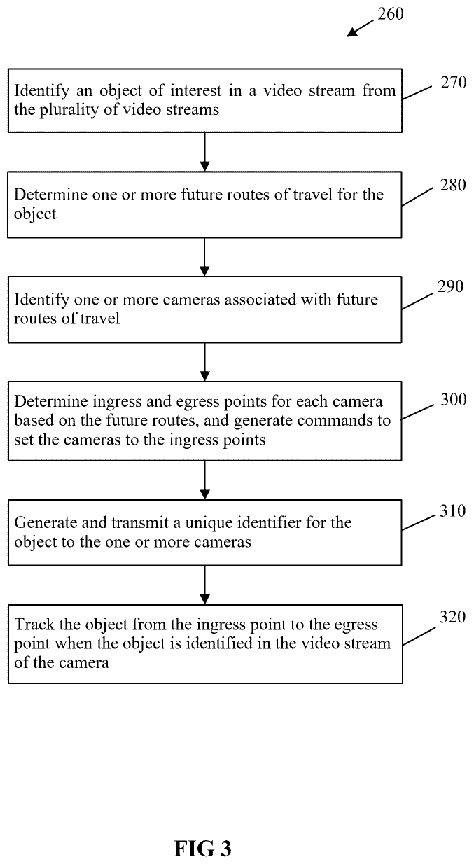

The present disclosure further provides a method for tracking an object in video streams. FIG. 3 is a flowchart depicting steps of a method 260 for tracking an object in video streams. The method 260 may be executed by the system 100 or any other suitable components operating singularity or in distributed fashion. The method 260 includes a step of identifying an object of interest in a video stream from the plurality of video streams (Step 270). The object of interest may be identified based on input received from a user related to the object of interest or prestored details of the object of interest. The object may be identified in the video stream by implementing image processing techniques such as convolutional-neural-network (CNN) detectors, background subtraction, template matching, or hybrid rule-based heuristics.

The method 260 further includes a step of determining one or more future routes of travel for the object (Step 280). Artificial intelligence techniques may be implemented to determine the future route(s). For example, the route generator 190 of the system 100 may be trained with path historically taken by objects similar to the objects of interest. The route generator 190 may utilize historic data to determine the future route for the object of interest. In some other aspects, the future route(s) may be determined based on entry and exit points available for the object of interest. In some other aspects, predefined paths for different objects may be stored in the database 205. The predefined path of an object matching with the object of interest may be extracted as the future path for the object of interest, or multiple candidate paths may be scored probabilistically.

The method 260 further includes a step of identifying one or more cameras associated with future routes of travel (Step 290). In some aspects, the processing unit 130 identifies video streams having the future path. The cameras 110 capturing those video streams may be identified as capturing the future route(s). In some other aspects, details of the cameras 110 associated with capturing various sections of the site may be stored in the database 205. Further, the sections are identified having the future routes. The cameras associated with the sections having the future paths are identified for further processing.

The method 260 further includes a step of determining ingress and egress points for each camera based on the future routes, and generating commands to set the cameras to the ingress points (Step 300). The ingress and egress points for each camera 110 may be determined based on the future routes. In some aspects, the commands may be generated by the processing unit 130 to set all identified cameras 110 to respective ingress points. In some other aspect, the processing unit 130 may generate commands to set the camera 110 capturing immediately next section of the future route. The processing unit 130 may generate commands thereby conserving PTZ motor cycles and bandwidth.

The method 260 further includes a step of generating and transmitting a unique identifier for the object to the one or more cameras (Step 310). The unique identifier may be a unique feature of the object or a combination of two or more features of the object of interest (e.g., color histogram +silhouette, license plate+vehicle class, or biometric hash+clothing descriptor).

The method 260 further includes a step of tracking the object from the ingress point to the egress point when the object is identified in the video stream of the camera (Step 320). The cameras 110 utilize the unique identifier for identifying the object of interest in the section. Once the object is identified, the camera 110 continues to track the object up to the egress point, optionally handing off tracking data to downstream analytics such as dwell-time measurement or behavior anomaly detection.

The method 260 may further include a step of displaying the video stream having the object as a primary view on a user interface. The processing unit 130 receives the video stream from the camera 110 having the object in the video stream, and the video stream is displayed in the user interface 120 as the primary view. The method 260 further includes a step of displaying video streams through which the object passed through and/or is predicted to potentially pass on the user interface as a secondary view. The processing unit 130 receives video streams from other cameras 110 that previously or prospectively contain the object based on the future routes. The processing unit 130 displays the video streams on the user interface as a secondary view on the user interface 120, and may concurrently render trajectory overlays, confidence heat-maps, or alarm indicators to aid operator comprehension.

In one implementation, the system 100 is employed for a secure-delivery application. The system 100 identifies a vehicle based on plate number or roof number. The system 100 further initiates a tracking session if a delivery is scheduled. The system 100 may be configured to automatically share a video feed to a delivery company, providing a tour view with no control of the tracking. The system 100 may track a delivery staff based on identification such as standard uniform and record the number of delivery objects. The system 100 utilizes the base tracking workflow, with additional alarms for fall detection, crowd density anomalies (for example, more individuals than the number that exited the vehicle), detour from the regular track, variance from the normal duration and object left behind or taken. Once the delivery staff have returned to the vehicle and the number of delivery objects has been recorded, the system 100 generates and shares a report with the delivery company via secure application-programming interface (API) or encrypted email, thereby supporting chain-of-custody requirements.

In another implementation, the system 100 is employed to track a last individual leaving the premises, for example, a final key-holder departing a secured premises. The system 100 may track the individual, and alerts an operator if an alarm is generated. The tracking session is initiated when a key holder begins the lock up procedure. The system 100 tracks the individual to a known vehicle based on License Plate Recognition or to a specified location. The system 100 generates an alarm for fall detection, crowd proximity anomalies (near to the individual), variance from the normal duration of the egress procedure and the individual entering a vehicle with an unexpected license plate number or deviating from an authorized path.

While the invention has been described with reference to a preferred aspect, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular aspect disclosed as the best mode contemplated for carrying out this invention, but that the invention will include all aspects falling within the scope of the appended claims.

### Configuration of Exemplary Aspects

The construction and arrangement of the systems and methods as shown in the various exemplary aspects are illustrative only. Although only a few aspects have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied, and the nature or number of discrete elements or positions can be altered or varied. Accordingly, all such modifications are intended to be included within the scope of the present disclosure. The order or sequence of any process or method steps can be varied or re-sequenced according to alternative aspects. Other substitutions, modifications, changes, and omissions can be made in the design, operating conditions, and arrangement of the exemplary aspects without departing from the scope of the present disclosure.

The present disclosure contemplates methods, systems, and program products on any machine-readable media for accomplishing various operations. The aspects of the present disclosure can be implemented using existing computer processors, or by a special purpose computer processor for an appropriate system, incorporated for this or another purpose, or by a hardwired system. Aspects within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures, and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

1. A tracking system comprising:
a plurality of cameras configured to capture a plurality of video streams; and
a processing unit having a memory and a processor in communication with the memory, the processor configured to:
identify an object of interest in a video stream from the plurality of video streams;
determine one or more future routes of travel for the object;
identify one or more cameras whose respective fields of view overlap with future routes of travel;
determine ingress and egress points for each camera based on the future routes, and generate commands to set the cameras to the ingress points; and
generate and transmit a unique identifier for the object to the one or more cameras, wherein the cameras are configured to track the object from the ingress point to the egress point when the object is identified in the video stream of the camera.

2. The video tracking system of claim 1, wherein the processor is configured to display the video stream having the object as a primary view on a user interface.

3. The video tracking system of claim 2, wherein the processor is configured to display video streams having the object passed through and/or potentially pass on the user interface as a secondary view.

4. The video tracking system of claim 1, wherein the processor is configured to re-establish tracking using the unique identifier of the object when the object takes a route other than the future route.

5. The video tracking system of claim 1, wherein, each camera being at least one of a fixed-focus camera, a pan-tilt-zoom (PTZ) camera, a multisensory panoramic camera, or a thermal or depth-sensing camera.

6. The video tracking system of claim 1, wherein one or more cameras are pan-tilt-zoom (PTZ) cameras.

7. The video tracking system of claim 1, wherein the processor is configured to receive the video streams having the object passed through, and generate a video showing travel of the object based on received video streams.

8. The video tracking system of claim 1, wherein the processor is configured to determine one or more future routes of travel for the object using at least one of historic-path analytics, rule-based logic, or machine-learning prediction.

9. A method for tracking an object in video streams, the method comprising:
identifying an object of interest in a first video stream captured by a first camera of a plurality of video streams;
predicting one or more future routes of travel for the object;
selecting, from the plurality of cameras, at least one downstream camera whose field of view includes the one or more future routes;
determining an ingress point and an egress point for the at least one downstream camera, and generating a command that positions the at least one downstream camera at the ingress point;
generating and transmitting a unique identifier for the object to the at least one downstream camera; and
tracking, by the at least one downstream camera, the object from the ingress point to the egress point upon detecting the unique identifier.

10. The method of claim 9, further comprising displaying, on a user interface, a primary view containing the object of interest.

11. The method of claim 10, further comprising displaying, as at least one secondary view, a video stream in which the object has previously appeared or is predicted to appear.

12. The method of claim 9, wherein at least one camera is a PTZ camera, and the command that positions the at least one downstream camera at the ingress point comprises PTZ preset coordinates.

13. The method of claim 9, wherein predicting one or more future routes of travel for the object comprises applying a machine-learning model trained on historic object-trajectory data.

14. A computer-implemented method for tracking an object of interest in a plurality of video streams, the method comprising:
(a) identifying the object of interest in a first video stream captured by a first camera of a plurality of cameras;
(b) predicting one or more future routes of travel for the object;
(c) cameras, at least one downstream camera whose field of view overlaps the one or more future routes;
(d) determining an ingress point and an egress point for the at least one downstream camera, and generating a command that positions the at least one downstream camera at the ingress point;
(e) generating and transmitting a unique identifier for the object to the at least one downstream camera; and
(f) tracking, by the at least one downstream camera, the object from the ingress point to the egress point upon detecting the unique identifier.

15. The computer-implemented method of claim 14, wherein the instructions further cause the one or more processors to display, on a user interface, a primary view that contains the object of interest in real time.

16. The computer-implemented method of claim 15, wherein the instructions further cause the one or more processors to concurrently display, as at least one secondary view, (i) a video stream in which the object of interest has previously appeared or (ii) a video stream in which the object of interest is predicted to appear.

17. The computer-implemented method of claim 14, wherein the plurality of cameras includes at least one pan-tilt-zoom (PTZ) camera, and the command generated in step (d) comprises PTZ preset coordinates that automatically reposition the PTZ camera to the ingress point.

18. The computer-implemented method of claim 14, wherein predicting the one or more future routes of travel in step (b) comprises executing a machine-learning model trained on historical trajectory data of objects similar to the object of interest.

19. The computer-implemented method of claim 14, wherein the instructions further cause the one or more processors to transmit tracking metadata that includes the unique identifier, camera identifiers, and time stamps to a remote client device or cloud-based analytics service via an application-programming interface (API).
